(19) United States
(12) Patent Application Publication
(10) Pub. No.: US 2026/0039488 A1
(43) Pub. Date: Feb. 5, 2026

(54) PRIVATE SMART CONTRACT EVENTS IN A PERMISSIONED BLOCKCHAIN

(71) Applicant: Oracle International Corporation, Redwood Shores, CA (US)

(72) Inventors: Carlo Innocenti, Wakefield, MA (US); Sharthak Mishra, Bengaluru (IN)

(21) Appl. No.: 18/790,517

(22) Filed: Jul. 31, 2024

(51) Int. Cl. H04L 9/00; G06F 21/62

(52) U.S. Cl. CPC H04L 9/50; G06F 21/6218

(57) ABSTRACT

Herein is privacy for a smart contract that contains chaincode that sends chaincode events. In a configurable and backwards compatible way, broadcast of a chaincode event can be restricted. Before committing a transaction to a blockchain and without storing a newly generated private event into the transaction, the following are stored into the private event: an event payload, a hash of the payload and, unlike the state of the art, an identifier of a subscriber or organization that can receive the private event. After committing the transaction is an asynchronous detection that the identifier of the subscriber is associated with the event and, responsively, the payload of the event is sent to the subscriber.

### FIELD OF THE DISCLOSURE

This disclosure relates to blockchain privacy.

### BACKGROUND

A blockchain is a distributed ledger that prevents shared persistent data from being altered. The following are various applications that may use a blockchain. For supply chain management, a blockchain can be used to track movement of goods and materials to improve transparency, efficiency, and traceability. A blockchain can be used to store and manage identities in a secure and verifiable way. For record keeping, a blockchain can be used to store and manage any type of record, such as medical records or land titles.

By itself, a blockchain is a passive data structure that may be extended with application-specific behavior such as according to a so-called smart contract that executes so-called chaincode when triggered by public events that are broadcast to all clients of the blockchain. While most permissioned (i.e. access controlled) blockchain platforms support an ability for a smart contract to trigger public events visible to any client who has access to the blockchain, there is no available support for private events that avoid sending an event to all clients.

The state of the art does not provide privacy disclosed herein. A decrease in privacy by the state of the art may be quantitatively measured as, for example: a) a count of bytes or fields or events delivered to an unintended client or b) a count of clients receiving an unintended event.

### BRIEF DESCRIPTION OF THE DRAWINGS

In the drawings:

FIG. 1 is a block diagram that depicts an example distributed system that increases privacy of a blockchain by avoiding, in a configurable and backwards compatible way, broadcast of events of smart contracts to clients;

FIG. 2 is a scenario diagram that depicts an example execution flow that increases privacy of a blockchain by avoiding, in a configurable and backwards compatible way, broadcast of events of smart contracts to clients;

FIG. 3 is a flow diagram that depicts an example computer process for restricted and efficient delivery of a private event;

FIG. 4 is a block diagram that illustrates a computer system upon which an embodiment of the invention may be implemented;

FIG. 5 is a block diagram that illustrates a basic software system that may be employed for controlling the operation of a computing system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Herein is privacy for a smart contract that contains chaincode that sends chaincode events. In a configurable and backwards compatible way, broadcast of a chaincode event can be restricted. This approach fulfils the following heightened privacy requirements. A private event is not stored on a public ledger. A private event is reported only by peers that belong to specified network organizations explicitly listed by the originator of the event. Private events are relayed, within an organization, only to event subscribers belonging to an explicit list of identities specified by the originator of the event. Without compromising privacy, past private events can be replayed starting from a specific block number or timestamp. State of the art chaincode events do not meet these requirements. This approach entails a new peer-level mechanism for selectively notifying eligible event listeners.

This approach leverages confidentiality provided by so-called private data collections and extends that confidentiality to allow a smart contract to trigger private events that are not published on the public ledger. Herein, a private event is not broadcast to all clients and, instead, is selectively multicast to a subset of organizations and clients as specified by the smart contract business logic. Private smart contract events allow the creation of event-based blockchain solutions that are not forced to broadcast more information than needed to more entities than needed.

This approach is backward compatible and may, for example, be implemented based on Hyperledger Fabric as discussed herein. Herein, a private event is tamper proof. For example based on cryptographic hashing, replay of a corrupted private event can be detected and rejected as discussed herein. Because the lifecycle of a smart contract may be defined by chaincode events that herein may be private, the state of a smart contract may be kept private even from some clients that can read or write the blockchain. Herein, a public blockchain may, for example, have an entirely or partially private smart contract whose lifecycle and state can be observed only by fine-grained permission.

### 1.0 Example Computer

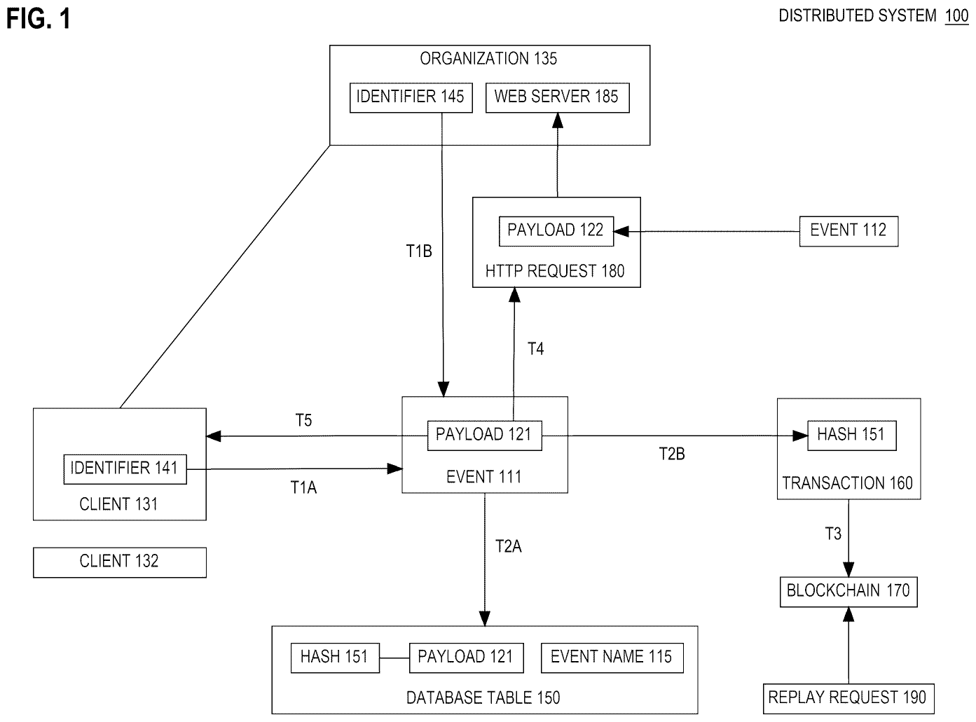

FIG. 1 is a block diagram that depicts example distributed system 100 that increases privacy of blockchain 170 by avoiding, in a configurable and backwards compatible way, broadcast of events 111-112 of smart contract(s) (not shown) to clients 131-132. Although not shown, distributed system 100 contains multiple computers such as a rack server such as a blade, a mainframe, a virtual machine, or other computing device. All components shown in FIG. 1 are variously stored or generated in volatile or nonvolatile storage of computer(s) in distributed system 100.

### 1.1 Blockchain Distributed Ledger

Blockchain 170 is a replicated persistent data structure for recording information in a tamper-proof way. Blockchain 170 is an online ledger that is a system of record for an ongoing stream of committed transactions. Blockchain 170 is immune to failure or fraud of one or a few computers in distributed system 100.

Blockchain 170 is tamper evident, which means that data recorded in blockchain 170 is immutable and cannot be secretly altered or deleted. This ensures the accuracy and trustworthiness of the information stored in blockchain 170. Security of blockchain 170 is based on hashes (i.e. cryptographic hash codes) stored in blockchain 170. For example, a hash of data in blockchain 170 may be stored in blockchain 170, and rehashing (i.e. regenerating a hash of) data in blockchain 170 always produces a same hash code so long as blockchain 170 is untampered.

In an embodiment, hashing entails cryptographic certificates operated by elliptic curve cryptography (ECC) and managed by public key infrastructure (PKI) that entails a public key and a private key. Herein, authentication and authorization to access blockchain 170 are separate tasks that are based on a credential that is a cryptographic certificate provided by one of clients 131-132. In an embodiment: a) blockchain 170 is permissionless, b) any client can read blockchain 170 without a credential, and c) writing blockchain 170 requires a credential issued by a certificate authority that, for example, might not be part of distributed system 100. In a preferred embodiment, blockchain 170 is permissioned and inaccessible without authentication and authorization of a certificate that distributed system 100 is configured to accept.

### 1.2 Event-Driven Lifecycle of Blockchain

Blockchain 170 has an application-specific lifecycle that generates and transmits application-specific events according to a so-called smart contract (not shown) that may, for example, be implemented by so-called chaincode (not shown) that is application-specific logic that operates when any or particular transactions are being prepared for committing to blockchain 170. In other words, chaincode is a behavioral extension for blockchain 170 that may, for example, execute when transaction 160 is being prepared. For example, chaincode may be implemented in a scripting language such as JavaScript or python that generates event 111 or 112 that are referred to herein as chaincode events.

The lifecycle of transaction 160 entails a sequence of phases that are endorsement, followed by commit, followed by notification. Chaincode execution and event generation occur during the endorsement phase. Transaction 160 is appended onto blockchain 170 during the commit phase. Event 111 is transmitted to a configurable subset of clients 131-132 during the notification phase as discussed later herein.

Event transmission herein is based on a publish-subscribe (pub-sub) behavioral pattern. Transmission herein of events 111-112 is not broadcast to all clients of blockchain 170. Herein, both a publisher and a subscriber may: a) be clients of blockchain 170 and b) limit which events will the subscriber receive. For example, a publisher may avoid transmitting a particular event to some clients, even if the client has subscribed to a particular so-called channel that the publisher uses to transmit the event.

As follows during the lifecycle of transaction 160, shown times T1 (i.e. T1A-B) through T5 occur in an ordering according to their shown numbering. Shown times TIA-B may, for example, be a same time that is referred to herein as time T1. Likewise, shown times T2A-B may, for example, be a same time that is referred to herein as time T2.

The endorsement phase includes times T1-2. The commit phase is time T3. The notification phase includes times T4-5.

Each of times T1-5 is shown as an arrow that, as discussed below, may or may not entail data transmission (e.g. between two computers over a communication network). That is, depending on which lifecycle phase or which shown time, one, two, or three computers may be involved.

### 1.3 Event Generation by Chaincode of Smart Contract

Before the endorsement phase (i.e. before time T1), transaction 160 is generated by a client (e.g. neither of clients 131-132) that comprises one of the computers in distributed system 100. As follows, additional data will be inserted into transaction 160 during the endorsement phase that generates event 111 that may, for example, be generated by execution of chaincode that is part of a smart contract.

At time T1, event 111 is generated, for example by execution of chaincode. In an embodiment, event 111 is a well-formed semi-structured document such as JavaScript object notation (JSON) or extensible markup language (XML). The following is an example JSON event 111.

```
{
  “visibleTo”: {
    “testOBPInstance”: [
      “eriberto”
          ]
        },
  “payload”: {
    “from”: “A”,
    “to”: “B”,
    “amount”: 87
  }
}
```

In the above example JSON event 111, the following terms have the following meanings.
testOBPInstance identifies organization 135. Event 111 will not be transmitted to a subscriber that is not a member of organization 135. As shown in FIG. 1, client 131 is a member of organization 135.
eriberto identifies client 131. Event 111 will be transmitted to client 131 so long as client 131 is subscribed to the channel that will transmit event 111. Channel subscription is discussed later herein. Event 111 will not be transmitted to client 132 even if client 132 is a member of organization 135 and even if client 132 is subscribed to the channel that will transmit event 111.
payload is payload 121 that contains values of application-specific data fields. Payload 121 may be a data structure that contains substructures nested within substructures according to the full expressiveness of JSON or XML.

In an embodiment, client 131 has a certificate that contains a respective so-called common name (CN) for each of components 131 and 135. For example, testOBPInstance and eriberto may be identifiers that are common names.

In another example, the above example JSON event 111 may instead contain the following example visibility that a publisher (e.g. chaincode) may specify to transmit event 111 to one particular subscriber in a first organization and two subscribers in a second organization.

```
“visibleTo”: {
  “msp1”:
  [“cn1.1”],
  “msp2”: [“cn2.1”, “cn2.2”]
```

In an embodiment, chaincode generates event 111 by: a) generating payload 121 and b) invoking a subroutine (e.g. of blockchain 170) that generates event 111 while passing payload 121 as an argument to the subroutine. In an embodiment, the subroutine is an innovative implementation of Hyperledger Fabric's PutPrivateData function as follows. In an embodiment, distributed system 100 contains an implementation of Hyperledger Fabric.

### 1.4 Event Privacy Mechanisms

Hyperledger Fabric is an open-source framework designed for developing enterprise-grade blockchain applications. In a Hyperledger Fabric embodiment, blockchain 170 is permissioned, which means that access to blockchain 170 is restricted to authorized members (e.g. organizations and clients), which makes Hyperledger Fabric suitable for business use cases where privacy and control are crucial.

In addition to the public ledger, Hyperledger Fabric allows storing confidential data in private collections accessible only to authorized parties. In Hyperledger Fabric, chaincode may be business logic for a network application. In Hyperledger Fabric, one or more chaincodes may implement the behavior of a smart contract written in supported languages such as Go, Node.js (i.e. JavaScript), or Java.

In the state of the art, Hyperledger Fabric's SetEvent function is invoked by chaincode to send an event. Herein, SetEvent is not used.

In the state of the art, Hyperledger Fabric's PutPrivateData function is used only for data storage and not used for events. The innovative implementation of PutPrivateData herein is backwards compatible and its function signature is unchanged. The following is an example invocation of the innovative implementation of PutPrivateData herein.

$$PutPrivateData ( 〈 pdcID 〉 , “ obp\_privateEvent \_ ” + 〈 privateEventName 〉 , 〈 privateEventData 〉 )$$

The following terms have the following meanings in the above example invocation.
pdcID is a text string that is the name of a private data collection that may, for example, be a collection stored in a database or file.
privateEventName is event name 115, as discussed below, that is a text string that is the name of event 111. Herein, an event name identifies a kind (i.e. type) of event, and there may be multiple distinct instances of a same event type. For example, distinct events 111-112 may or may not have a same name.
obp_privateEvent_is a string literal that is an innovative prefix that should be prepended onto the event name to indicate that PutPrivateData is being invoked for an event instead of passive data.
privateEventData is event 111.

Example internal operation of the innovative implementation of PutPrivateData occurs at time T2 as follows. PutPrivateData is invoked at time T2 that consists of times T2A-B that may, for example, be a same time. PutPrivateData generates cryptographic hash 151 from payload 121 and, at times T2A-B, stores hash 151 into respective components 160 and 150 as shown.

At time T2A in the shown embodiment, PutPrivateData inserts a new table row into database table 150 to represent event 111. In the shown embodiment, each of data elements 115, 121, and 151 is stored in a respective distinct table column in database table 150. Although not shown, database table 150 may contain columns for event metadata such as any non-payload field in event 111 such as the visibleTo field. In an embodiment, database table 150 is exactly one private data collection as discussed above.

At time T2B, hash 151 is stored into transaction 160 and, at time T3, transaction 160 and hash 151 are (i.e. persistently) committed into blockchain 170. In an embodiment: a) a two phase commit (2PC) has a lifecycle that consists of a prepare phase followed by the commit phase discussed earlier herein. In an embodiment, the prepare phase occurs during the endorsement phase discussed earlier herein. In various embodiments, in addition to being a blockchain transaction, transaction 160 may be one, some, or all of: an extended architecture (XA) distributed transaction, an atomic consistent isolated durable (ACID) transaction, and a database transaction.

At time T3, hash 151 becomes tamper proof, which means that event 111 and payload 121 become tamper proof at time T3. Any future copy of event 111 will: a) cause exact regeneration of hash 151 that is available on the public ledger (i.e. blockchain 170) or b) be detected and rejected as inauthentic.

### 1.5 Efficient Event Delivery

In an embodiment, event 111 is delivered asynchronously after time T3 (i.e. after transaction 160 was committed). In an embodiment after time T3, an ordering service (e.g. Kafka in Hyperledger Fabric) broadcasts a committed block that contains transaction 160 to all peers in the network. Peers can then process the block and extract the events associated with the transactions within the block.

In the shown embodiment, organization 135 operates web server 185 as a peer that relays events from blockchain 170 to clients in organization 135 as follows. At time T4, multiple distinct events are stored into hypertext transfer protocol (HTTP) request 180 that is a data structure that is sent from an ordering service computer (not shown) in distributed system 100 to web server 185 that is hosted in a computer in organization 135. For example, HTTP request 180 may contain payloads 121-122 of respective events 111-112 that were generated during distinct respective transactions.

Although not shown, HTTP request 180 may contain event metadata such as any non-payload field in event 111 such as the visibleTo field, which web server 185 may inspect to detect, for example, that: a) payload 122 should be transmitted by web server 185 to both clients 131-132, and b) at time T5, payload 121 should be transmitted by web server 185 to client 131 but not to client 132 event though client 132 is a member of organization 135. In an embodiment, web server 185 is a representational state (REST) server. In an embodiment, all network transmissions to and from web server 185 use HTTP secure (HTTPS).

The following is an example body of HTTP request 180.

```
{
  <private event name1>: <pe1>,
  <private event name2>: <pe2>,
  ...
}
```

In the above example body of HTTP request 180, the following terms have the following meanings.
pe1-pe2 are respective events 111-112.
name1 is event name 115.

The following is an example event 111 as contained in HTTP request 180.

```
{
  “type”:
  “privateChaincode”,
  “subid”: “...”,
  “channel”: “default”,
  “eventMsg”: {
    “TxID”:
    “6cf858cdfc7f94b26fcfd3c1eabb914fd0a25464a4064b28be76f4c9c408
    3468”, “ChaincodeID”: “cctest1”,
    “EventName”: “_{——}obp_{——}privateEvents”,
    “Payload”:
    “eyJUcmFuc2ZlckRldGFpbHMiOnsiYW1vdW50IjoxMCwiZnJvbSI6IkEiLCJ0
    byI6IkIifX0=”, “BlockNumber”: 11
  },
  “sourceURL”: “...”
}
```

In the above example event 111, the following terms have the following meanings.
The value of field subid is identifier 141.
The value of field TxID is an identifier of transaction 160.
The value of field Payload is a base-64 (i.e. not hashed) alphanumeric encoding of payload 121.

HTTP request 180 accelerates blockchain 170 and the ordering service computer in two ways as follows. For event 112 that should be broadcast to multiple clients 131-132, a state of the art ordering service would directly send payload 122 to each of clients 131-132 in a respective separate network transmission, which is two network transmissions. By instead sending HTTP request 180, the ordering service herein sends only one network transmission, not two and, by decreased network transmissions: a) network bandwidth is conserved, and b) computational load of the ordering service is decreased, which is acceleration of a computer.

A state of the art ordering service would directly send each of payloads 121-122 to client 131 in a respective separate network transmission, which is two network transmissions. By instead sending HTTP request 180 that contains both payloads 121-122, the ordering service herein sends only one network transmission, not two, which conserves network bandwidth and accelerates the ordering service. Thus, the ordering service herein sends only one HTTP request 180 to deliver payload 121 to client 131 and payload 122 to clients 131-132, for which a state of the art ordering service would need three separate network transmissions.

### 2.0 Example Transaction of Smart Contract

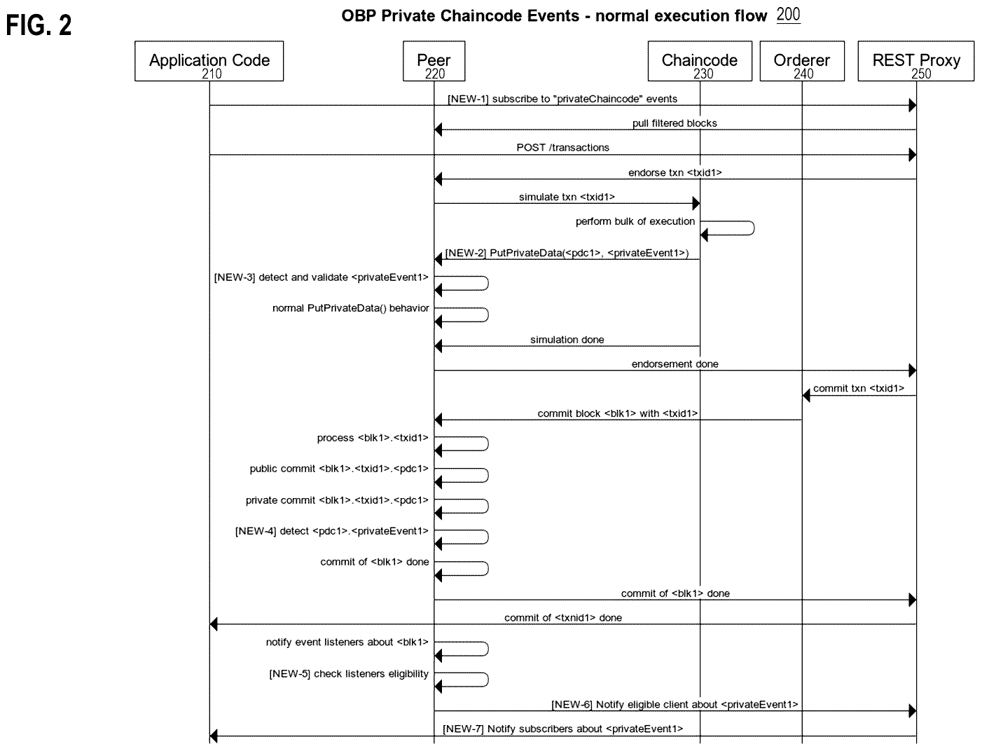

FIG. 2 is a scenario diagram that depicts example execution flow 200 that increases privacy of blockchain 170 by avoiding, in a configurable and backwards compatible way, broadcast of events 111-112 of smart contract(s) to clients. Components of FIGS. 1-2 may be related as follows. Client 131 contains and executes application code 210. Peer 220 is a computer in distributed system 100. Chaincode 230 is contained in and executed by a computer in distributed system 100. Orderer 240 is the innovative ordering service discussed earlier herein. Representational state (REST) proxy 250 is web server 185.

Each horizontal arrow connects one or two of components 210, 220, 230, 240, and 250 and represents an interaction between those components. Each of shown interactions new 1-7 is individually innovative as follows. In FIG. 2, time flows downwards. For example, interaction new 1 occurs before interaction new 2.

In interaction new 1 before time T1 in FIG. 1, REST proxy 250 receives a new subscription for event type “privateChaincode”. In response, REST proxy 250 generates a peer communication channel for filteredBlockEvents with private chaincode events enabled. The following is an example private event subscription request.

```
{
  “type”:
  “privateChaincode”
  ,
  “chaincode”:
  “<chaincodeId>”,
  “callbackURL”:
  “...”,
  “callbackTLSCerts”
  : { },
  “expires”: “5m”,
  “seek”: “newest”,
  “event”: “.*”,
  “maxCallbackRetry”
  : 15,
  “role”:“admin”
}
```

The following terms have the following meanings in the above example subscription request.
privateChaincode is a string literal that indicates private events herein that are not published to all clients.
newest specifies not to replay past events. In another example that does not specify newest, replay request 190 is a subscription request that causes resending past events to the subscriber.
.* is a wildcard pattern that matches all event names. A subscription request may instead specify particular even type(s).
chaincode Id is an identifier of a chaincode. A subscription for event name 115 will not receive an event from a different chaincode even if the event type is event name 115.

In interaction new 2 at time T2, chaincode 230 in peer 220 invokes PutPrivateData as discussed earlier herein. In interaction new 3 at time T2, the innovative implementation of PutPrivateData detects the innovative prefix that was prepended onto the event name to indicate that PutPrivateData is being invoked for an event instead of passive data as discussed earlier herein.

Likewise in interaction new 4 between times T3-T4, peer 220 detects the innovative prefix that was prepended onto the event name to indicate that committed transaction 160 contains a private event that is not passive data. In interaction new 5 at time T4, peer 220 detects that event 111 should be transmitted only to client 131, which means that event 111 should be transmitted, in interaction new 6 at time T4, in HTTP request 180 that is a REST request to REST proxy 250 in organization 135 but, in some examples, not transmitted to REST proxies in other organizations that also use blockchain 170.

In interaction new 7 at time T5, REST proxy 250 relays (i.e. transmits) payload 121 to client 131 as discussed earlier herein.

### 3.0 Example Event Restriction Process

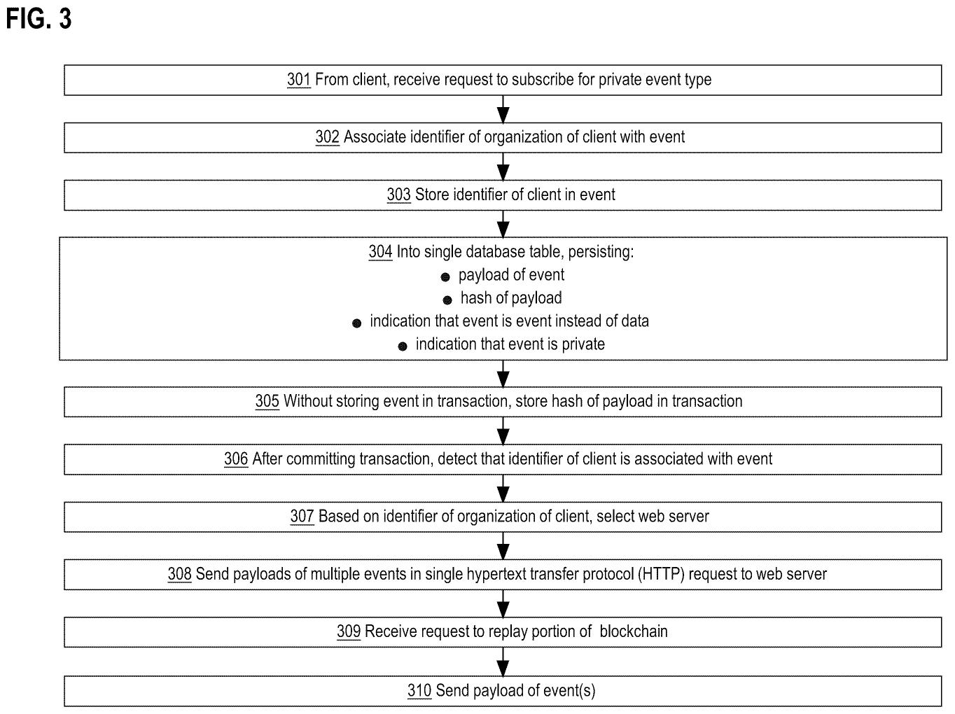

FIG. 3 is a flow diagram that depicts an example process that distributed system 100 may perform for restricted and efficient delivery of private event 111. Components of FIGS. 1-3 may be related as follows. As discussed earlier herein, distributed system 100 contains multiple computers having distinct or redundant respective roles and, in some cases, one computer may have multiple roles. In an embodiment, each of components 220, 230, and 250 is hosted by a separate computer. The following discussion involves an example assignment of the steps of the process of FIG. 3 for performance by respective computers.

In an embodiment, web server 185 performs step 301. In an embodiment, peer 220 may be a computer that performs steps 302-305 during the endorsement phase and steps 306-310 during the notification phase as discussed earlier herein. In an embodiment, peer 220 may perform all of the steps of the process of FIG. 3.

Step 301 is interaction new 1 in FIG. 2. Immediately before interaction new 2, event 111 is generated, which entails steps 301-302 that associates respective identifiers 141 and 145 with event 111. For example, steps 301-302 may store respective identifiers 141 and 145 into event 111 as discussed earlier herein.

Into single database table 150 in step 304, the innovative implementation of PutPrivateData persists some or all of: a) payload 121, b) hash 151, c) an indication that event 111 is an event instead of passive data, and d) an indication that event 111 is private. Without storing components 111 and 121 into transaction 160, step 305 stores hash 151 into transaction 160. Database table 150 may later be used to access payload 121. However, public permissioned access to blockchain 170 does not include access to components 115, 121, and 150 that remain private. For example, inspection of hash 151 does not reveal event name 115 and does not reveal that hash 151 represents an event instead of passive data.

After transaction 160 was committed into blockchain 170, step 306 in interaction new 4 detects that event 111 contains identifiers 141 and 145. Based on identifier 145, step 307 selects web server 185, and step 308 sends multiple payloads 121-122 in single hypertext transfer protocol (HTTP) request 180 to web server 185.

Event replay is demonstrated by steps 309-310. Step 309 receives request 190 to replay a portion of blockchain 170. In an embodiment, replay request 190 does not contain an identifier of any of components 111 and 160. For example, replay request 190 may implicitly cause replay of private events of entire blockchain 170 or of a particular time range in blockchain 170.

During replay, step 310 sends payloads of event(s) to a client that sent replay request 190. Replay will not replay an event to a client that was not identified in the visibleTo metadata field of the event as discussed earlier herein.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

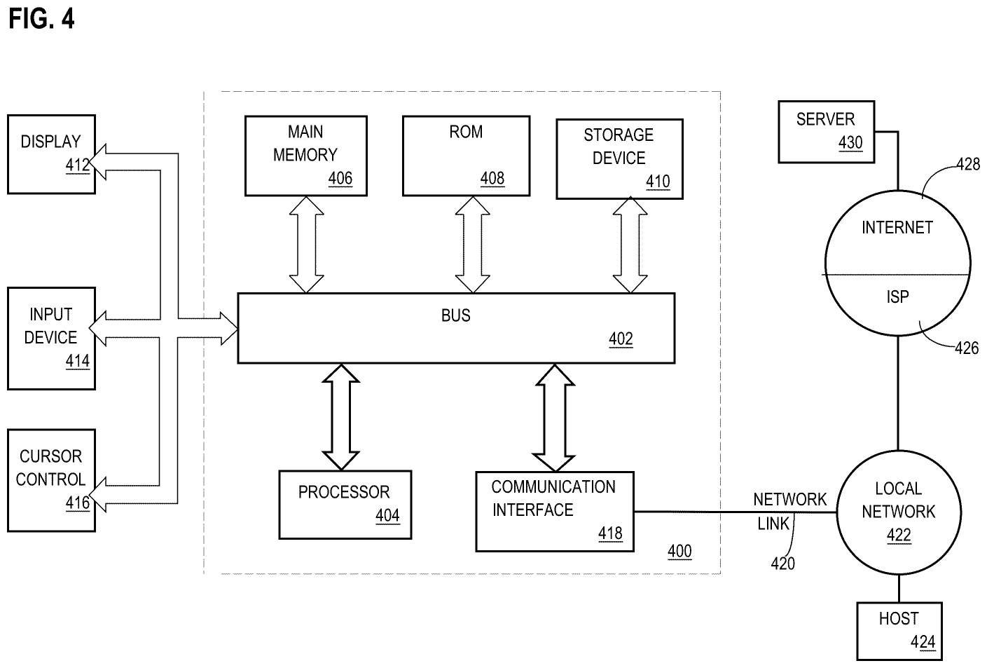

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 410. Volatile media includes dynamic memory, such as main memory 406. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

### Software Overview

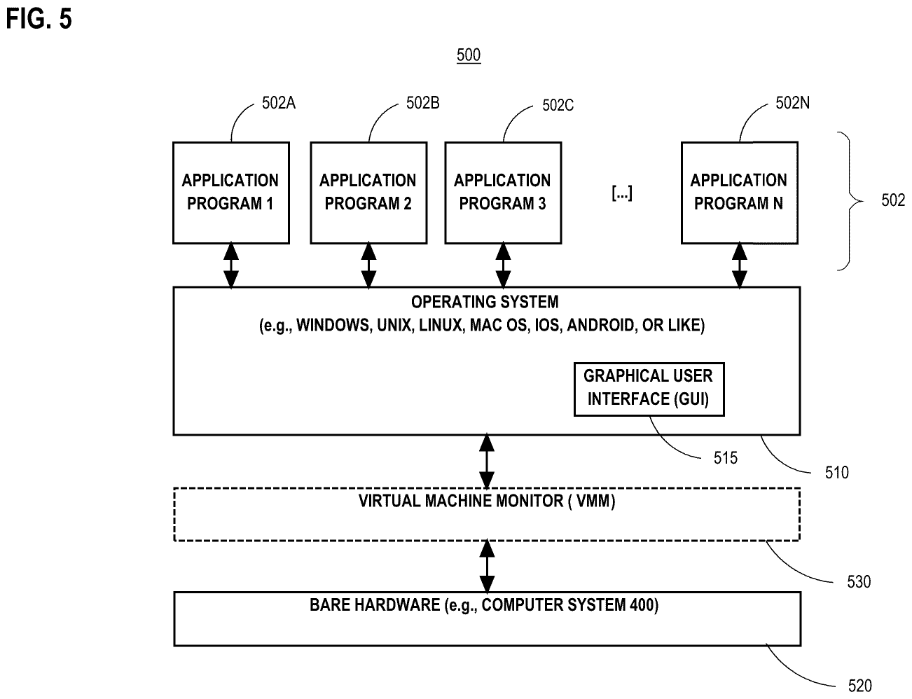

FIG. 5 is a block diagram of a basic software system 500 that may be employed for controlling the operation of computing system 400. Software system 500 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 500 is provided for directing the operation of computing system 400. Software system 500, which may be stored in system memory (RAM) 406 and on fixed storage (e.g., hard disk or flash memory) 410, includes a kernel or operating system (OS) 510.

The OS 510 manages low-level aspects of computer operation, including managing execution of processes, memory allocation, file input and output (I/O), and device I/O. One or more application programs, represented as 502A, 502B, 502C . . . 502N, may be “loaded” (e.g., transferred from fixed storage 410 into memory 406) for execution by the system 500. The applications or other software intended for use on computer system 400 may also be stored as a set of downloadable computer-executable instructions, for example, for downloading and installation from an Internet location (e.g., a Web server, an app store, or other online service).

Software system 500 includes a graphical user interface (GUI) 515, for receiving user commands and data in a graphical (e.g., “point-and-click” or “touch gesture”) fashion. These inputs, in turn, may be acted upon by the system 500 in accordance with instructions from operating system 510 and/or application(s) 502. The GUI 515 also serves to display the results of operation from the OS 510 and application(s) 502, whereupon the user may supply additional inputs or terminate the session (e.g., log off).

OS 510 can execute directly on the bare hardware 520 (e.g., processor(s) 404) of computer system 400. Alternatively, a hypervisor or virtual machine monitor (VMM) 530 may be interposed between the bare hardware 520 and the OS 510. In this configuration, VMM 530 acts as a software “cushion” or virtualization layer between the OS 510 and the bare hardware 520 of the computer system 400.

VMM 530 instantiates and runs one or more virtual machine instances (“guest machines”). Each guest machine comprises a “guest” operating system, such as OS 510, and one or more applications, such as application(s) 502, designed to execute on the guest operating system. The VMM 530 presents the guest operating systems with a virtual operating platform and manages the execution of the guest operating systems.

In some instances, the VMM 530 may allow a guest operating system to run as if it is running on the bare hardware 520 of computer system 500 directly. In these instances, the same version of the guest operating system configured to execute on the bare hardware 520 directly may also execute on VMM 530 without modification or reconfiguration. In other words, VMM 530 may provide full hardware and CPU virtualization to a guest operating system in some instances.

In other instances, a guest operating system may be specially designed or configured to execute on VMM 530 for efficiency. In these instances, the guest operating system is “aware” that it executes on a virtual machine monitor. In other words, VMM 530 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprise two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure and applications.

The above-described basic computer hardware and software and cloud computing environment presented for purpose of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
before committing a transaction to a blockchain:
associating an identifier of a client with an event that contains a payload,
storing a hash of the payload of the event in the transaction without storing the payload in the transaction;
detecting, after committing the transaction, that the identifier of the client is associated with the event; and
sending, responsive to said detecting, the payload of the event to the client.

2. The method of claim 1 wherein:
the method further comprises before said committing the transaction, associating an identifier of an organization of the client with the event;
said sending the payload of the event to the client comprises:
based on the identifier of the organization of the client, selecting a web server, and
sending the payload of the event to the web server.

3. The method of claim 2 wherein said sending the payload of the event to the web server comprises to the web server, sending payloads of multiple events in a single hypertext transfer protocol (HTTP) request.

4. The method of claim 1 wherein the blockchain is permissionless.

5. The method of claim 4 further comprising from the client before said associating, receiving a request to subscribe for a private event.

6. The method of claim 1 wherein said associating the identifier of the client comprises storing the identifier of the client in the event.

7. The method of claim 1 wherein:
said event is a first event;
the method further comprises:
associating an identifier of a second client with a second event that contains a payload, storing a hash of the payload of the second event in the transaction, and
deciding not to send the payload of the first event to the second client.

8. The method of claim 1 wherein said before committing the transaction to the blockchain comprises before a commit phase of a two phase commit (2PC) that consists of a prepare phase followed by the commit phase.

9. The method of claim 1 further comprising:
receiving a request to replay a portion of the blockchain, wherein the request does not identify the event;
responsive to said request to replay, sending the payload of the event.

10. The method of claim 1 further comprising in a single database table, persisting at least three selected from a group consisting of: the payload of the event, the hash of the payload of the event, an indication that the event is an event, and an indication that the event is private.

11. One or more non-transitory computer-readable media storing instructions that, when executed by one or more processors, cause:
before committing a transaction to a blockchain:
associating an identifier of a client with an event that contains a payload,
storing a hash of the payload of the event in the transaction without storing the payload in the transaction;
detecting, after committing the transaction, that the identifier of the client is associated with the event; and
sending, responsive to said detecting, the payload of the event to the client.

12. The one or more non-transitory computer-readable media of claim 11 wherein:
the instructions further cause before said committing the transaction, associating an identifier of an organization of the client with the event;
said sending the payload of the event to the client comprises:
based on the identifier of the organization of the client, selecting a web server, and
sending the payload of the event to the web server.

13. The one or more non-transitory computer-readable media of claim 12 wherein said sending the payload of the event to the web server comprises to the web server, sending payloads of multiple events in a single hypertext transfer protocol (HTTP) request.

14. The one or more non-transitory computer-readable media of claim 11 wherein the blockchain is permissionless.

15. The one or more non-transitory computer-readable media of claim 14 wherein the instructions further cause from the client before said associating, receiving a request to subscribe for a private event.

16. The one or more non-transitory computer-readable media of claim 11 wherein said associating the identifier of the client comprises storing the identifier of the client in the event.

17. The one or more non-transitory computer-readable media of claim 11 wherein:
said event is a first event;
the instructions further cause:
associating an identifier of a second client with a second event that contains a payload,
storing a hash of the payload of the second event in the transaction, and
deciding not to send the payload of the first event to the second client.

18. The one or more non-transitory computer-readable media of claim 11 wherein said before committing the transaction to the blockchain comprises before a commit phase of a two phase commit (2PC) that consists of a prepare phase followed by the commit phase.

19. The one or more non-transitory computer-readable media of claim 11 wherein the instructions further cause:
receiving a request to replay a portion of the blockchain, wherein the request does not identify the event;
responsive to said request to replay, sending the payload of the event.

20. The one or more non-transitory computer-readable media of claim 11 wherein the instructions further cause in a single database table, persisting at least three selected from a group consisting of: the payload of the event, the hash of the payload of the event, an indication that the event is an event, and an indication that the event is private.
